(19) United States
(12) Patent Application Publication
(10) Pub. No.: US 2026/0060474 A1
(43) Pub. Date: Mar. 5, 2026

(54) AIR FRYER

(71) Applicant: Tsann Kuen (Zhangzhou) Enterprise Co., Ltd., Zhangzhou (CN)

(72) Inventors: Yixin ZHAN, Zhangzhou (CN); Bo Wei, Zhangzhou (CN)

(21) Appl. No.: 19/312,506

(22) Filed: Aug. 28, 2025

(30) Foreign Application Priority Data
Aug. 30, 2024 (CN) 20242213062.3

(51) Int. Cl. A47J 37/06

(52) U.S. Cl. CPC A47J 37/0641

(57) ABSTRACT

An air fryer includes an air fryer body and a ventilation system. The air fryer body includes a cooking container and a ventilation space divided into a first space, a second space, and a heat dissipation space. The ventilation system includes a first fan and a second fan. The first fan is located in the first space, and the second fan is located in the second space to drive air circulation in the second space and the heat dissipation space. The ventilation system includes an air outlet element having a first air outlet and a second air outlet. The first air outlet is connected to the first space, and the second air outlet is connected to the second space. A protruding enclosing wall of the air outlet element on a side of the air outlet element facing the second space and the heat dissipation space is elliptical.

### RELATED APPLICATIONS

This application claims priority to Chinese patent application number 202422130621.3, filed on Aug. 30, 2024. Chinese patent application number 202422130621.3 is incorporated herein by reference.

### FIELD OF THE DISCLOSURE

The present disclosure relates to an air fryer.

### BACKGROUND OF THE DISCLOSURE

An air fryer is a modern kitchen appliance that uses hot air circulation to cook food. A basic structure of the air fryer comprises several components: an outer shell, an inner pot, a heating element, a fan, a control panel, and a hot air duct. The outer shell is typically made of plastic or metal, protecting an internal structure and providing aesthetic appeal. The inner pot holds the food to be cooked and is typically made of stainless steel or aluminum with a non-stick coating for easy cleaning and to prevent food from sticking. The heating element primarily generates heat and can be an electric heating tube or a quartz tube. The fan circulates the hot air within the pot. The control panel provides an interface for users to set the temperature and time. The hot air duct provides a path for the hot air to circulate within the pot. During operation, the heating element generates high temperatures, and the fan forces the hot air through the hot air duct, heating the food. The hot air duct is formed between the outer shell and a hot air outlet, allowing the hot air to be evenly distributed throughout the pot. However, the hot air outlet is typically designed in a square shape, which can create dead angles where the hot air outlet meets the outer shell, hindering air flow in the hot air duct. Furthermore, this design flaw can also lead to heat accumulation at the location of the hot air outlet downstream of the hot air duct. The occurrence of heat accumulation will introduce several problems. First, the temperature at the hot air outlet will increase significantly, which places higher requirements on the materials of the air fryer. In particular, the hot air outlet needs to be made of materials with high heat resistance. If the heat resistance of the material is not good enough, the material may be damaged by high temperature, affecting the service life of the air fryer. Secondly, due to the obstruction of the hot air outlet, the air flow is not smooth, which will cause a lot of wind noise when the fan is running, reducing the user experience.

### BRIEF SUMMARY OF THE DISCLOSURE

The technical problem to be solved by the present disclosure is to provide an air fryer.

In order to solve the above technical problems, the present disclosure provides an air fryer, and the air fryer comprises an air fryer body and a ventilation system. The air fryer body comprises a cooking container and a ventilation space, and the ventilation space is divided into a first space, a second space, and a heat dissipation space. The heat dissipation space is arranged around the first space and is in communication with the second space, and the cooking container is placed in the first space. The ventilation system comprises a first fan and a second fan, and the first fan is located in the first space to drive air circulation in the cooking container. The second fan is located in the second space to drive air circulation in the second space and the heat dissipation space, and the ventilation system further comprises an air outlet element. The air outlet element comprises a first air outlet and a second air outlet. The first air outlet is connected to the first space, and the second air outlet is connected to the second space. A protruding enclosing wall of the air outlet element on a side of the air outlet element facing the second space and the heat dissipation space is elliptical.

In a preferred embodiment, the second space is located above the first space, and the air outlet element is placed laterally at a junction between the first space and the second space.

In a preferred embodiment, the first air outlet and the second air outlet extend laterally.

In a preferred embodiment, the first space and the second space are separated by a heat insulating cover.

In a preferred embodiment, an upper half part of the protruding enclosing wall is located in the second space, and a lower half part of the protruding enclosing wall is located in the heat dissipation space. The second fan is configured to drive air to flow along an outer side of the lower half part of the protruding enclosing wall and along an outer side of the upper half part of the protruding enclosing wall.

In a preferred embodiment, an air inlet of the first space is located on the heat insulating cover.

In a preferred embodiment, a bottom of the heat dissipation space comprises a bottom air outlet.

In a preferred embodiment, the air fryer body further comprises an upper shell, and the second space is formed between the upper shell and the heat insulating cover.

In a preferred embodiment, the air outlet element is connected to the upper shell.

In a preferred embodiment, a heat resistance of the upper shell is higher than a heat resistance of the air outlet element.

Compared with the existing techniques, the technical solution has the following advantages.
1. Since the protruding enclosing wall of the air outlet element on the side of the air outlet element facing the second space and the heat dissipation space is elliptical, the air flows along the protruding enclosing wall to reduce air resistance and air noise. Moreover, due to an elliptical streamlined structure, heat accumulation will not occur in a certain part, thereby better reducing temperature of the second space and the heat dissipation space. Thus a temperature of the upper shell will not be too high, and the temperature of the upper shell will be lower than a temperature of the air outlet element.
2. Since the upper shell and the air outlet element are not an integrated structure, and the upper shell can be made of a low-temperature-resistant material with a lower heat resistance than that of the air outlet element, which has a lower cost.

### BRIEF DESCRIPTION OF THE DRAWINGS

FIG. 1 is a perspective view of an air fryer in a preferred embodiment of the present disclosure.

FIG. 2 is a cross-sectional view of the air fryer in the preferred embodiment of the present disclosure.

FIG. 3 is a cross-sectional view of an air outlet element, a first space, and a second space in the preferred embodiment of the present disclosure.

FIG. 4 is a perspective view of the air outlet element that has been detached from a reminder of the air fryer in the preferred embodiment of the present disclosure.

FIG. 5 is a perspective view of the air fryer with an upper portion removed in the preferred embodiment of the present disclosure.

### DETAILED DESCRIPTION OF THE EMBODIMENTS

The present disclosure will be further described below with reference to the accompanying drawings and specific embodiments.

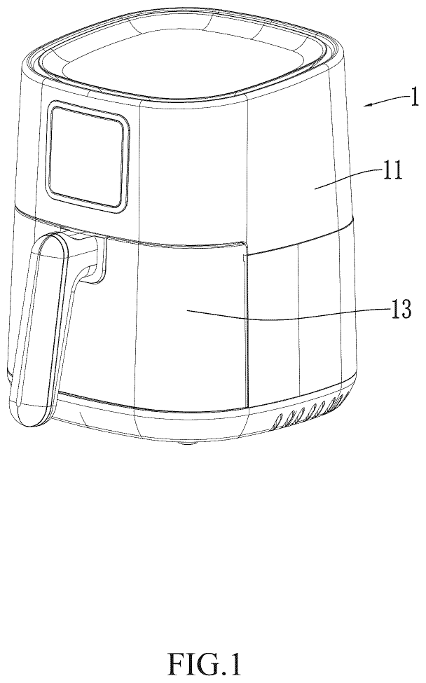

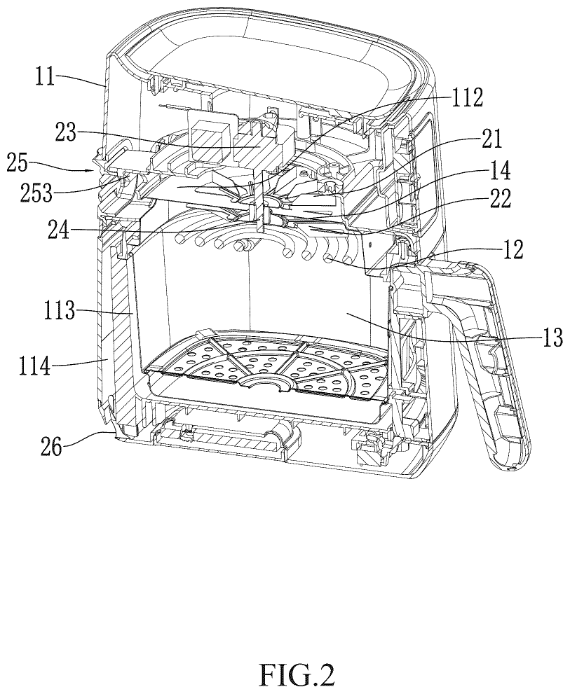

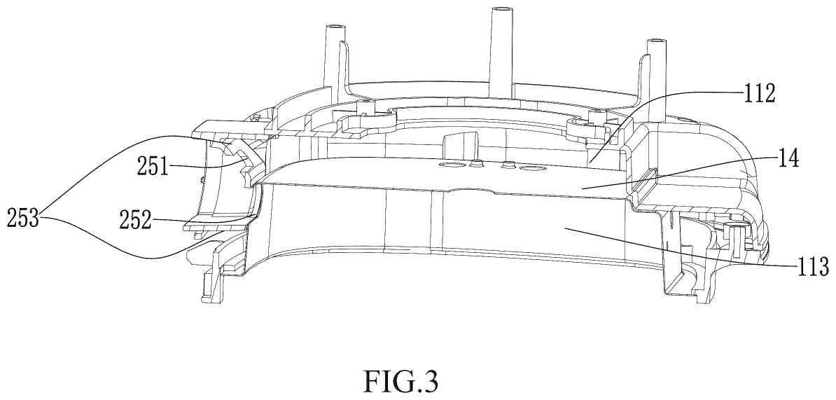

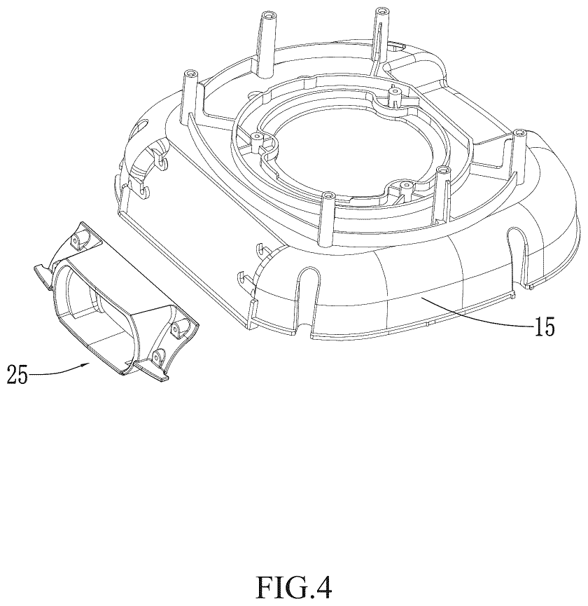

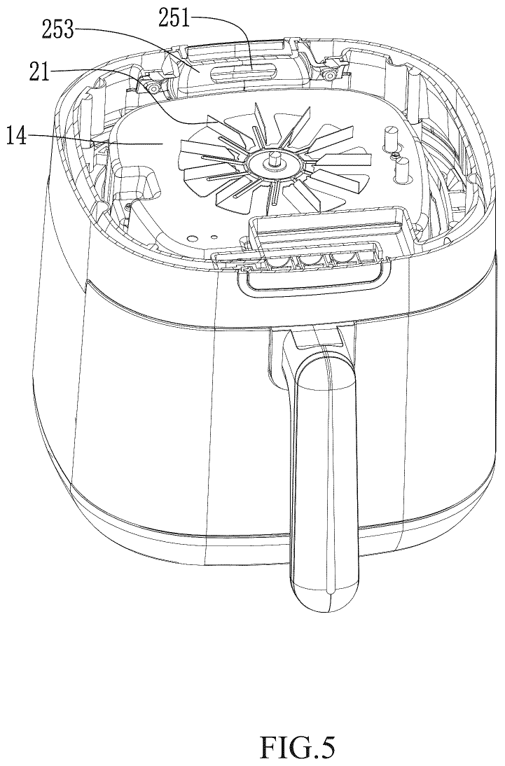

Referring to FIGS. 1 to 5, an air fryer is shown, and the air fryer comprises an air fryer body 1 and a ventilation system. The air fryer body 1 comprises an outer shell 11, a heating element 12, and a cooking container 13. The outer shell 11 forms a ventilation space, and the ventilation space is divided into a first space 113 and a second space 112 by a heat insulating cover 14. The ventilation space further comprises a heat dissipation space 114, and the heat dissipation space 114 is arranged around the first space 113 and is in communication with the second space 112. The ventilation system comprises a first fan 22, a second fan 21, and a drive mechanism 23. The drive mechanism 23 is arranged in the outer shell 11, the first fan 22 is located in the first space 113, and the second fan 21 is located in the second space 112. The drive mechanism 23 is connected to the second fan 21 and the first fan 22 at the same time through a drive shaft 24, and the drive shaft 24 passes through the heat insulating cover 14. The cooking container 13 is removably placed in the first space 113, and the heating element 12 is located below the first fan 22. When the first fan 22 rotates, air flows through the heating element 12 and blows toward the cooking container 13 to heat and cook food in the cooking container 13.

The first fan 22 is located in the first space 113 to drive air circulation in the cooking container 13, and the second fan 21 is located in the second space 112 to drive air circulation in the second space 112 and the heat dissipation space 114. The ventilation system further comprises an air outlet element 25, and the air outlet element 25 comprises a first air outlet 252 and a second air outlet 251. The first air outlet 252 is connected to the first space 113, and the second air outlet 251 is connected to the second space 112. A protruding enclosing wall 253 of the air outlet element 25 on a side of the air outlet element 25 facing the second space 112 and the heat dissipation space 114 is elliptical.

During use, the drive mechanism 23 drives the first fan 22 and the second fan 21 to rotate via the drive shaft 24. The air flows from an air inlet of the outer shell 11 first to the second space 112, passes through the heat insulating cover 14, and then enters the first space 113. The air then passes through the heating element 12 and enters the cooking container 13. Because the second fan 21 drives the air around the second fan 21, the air flows along a surrounding wall of the second space 112 and a surrounding wall of the heat dissipation space 114. At this time, due to an elliptical shape of the protruding enclosing wall 253 of the air outlet element 25, the air can flow along an outer side of the protruding enclosing wall 253, preventing heat accumulation around the air outlet element 25. The air in the first space 113 can flow out to an outside through the first air outlet 252, while the air in the second space 112 and the heat dissipation space 114 can flow out to the outside through the second air outlet 251.

In this embodiment, the second space 112 is located above the first space 113, and the air outlet element 25 is placed laterally at a junction between the first space 113 and the second space 112. Therefore, when the air flows along the protruding enclosing wall 253, the air flows along a long side of the ellipse. The first air outlet 252 and the second air outlet 251 extend laterally. Specifically, an upper half part of the protruding enclosing wall 253 is located in the second space 112, and a lower half part of the protruding enclosing wall 253 is located in the heat dissipation space 114. The second fan 21 drives the air to flow along an outer side of the lower half part of the protruding enclosing wall 253 and along an outer side of the upper half part of the protruding enclosing wall 253.

An air inlet of the first space 113 is located on the heat insulating cover 14. A bottom of the heat dissipation space 114 further comprises a bottom air outlet 26. Therefore, the air can also flow out through the bottom air outlet 26.

In this embodiment, the air fryer body 1 further comprises an upper shell 15, and the second space 112 is formed between the upper shell 15 and the heat insulating cover 14. Since the protruding enclosing wall 253 of the air outlet element 25 on the side of the air outlet element 25 facing the second space 112 and the heat dissipation space 114 is elliptical, the air flows along the protruding enclosing wall 253 to reduce air resistance and air noise. Moreover, due to an elliptical streamlined structure, heat accumulation will not occur in certain parts (i.e., specific areas), thereby better reducing temperature of the second space 112 and the heat dissipation space 114. Thus a temperature of the upper shell 15 will not be too high, and the temperature of the upper shell 15 will be lower than temperature of the air outlet element 25.

Since the upper shell 15 and the air outlet element 25 are not an integrated structure, the air outlet element 25 can be fixed to the upper shell 15 using fixing members such as bolts, but the disclosure is not limited thereto. Therefore, the upper shell 15 can be made of a low-temperature-resistant material with a lower heat resistance than that of the air outlet element 25, which has a lower cost.

The above is only a preferred specific implementation method of the present disclosure, but the design concept of the present disclosure is not limited to this. Any technician familiar with the technical field who uses this concept to make non-substantial changes to the present disclosure within the technical scope disclosed by the present disclosure shall be deemed to infringe the protection scope of the present disclosure.

What is claimed is:

1. An air fryer, comprising:
an air fryer body, and
a ventilation system, wherein:
the air fryer body comprises a cooking container and a ventilation space,
the ventilation space is divided into a first space, a second space, and a heat dissipation space,
the heat dissipation space is arranged around the first space and is in communication with the second space,
the cooking container is placed in the first space,
the ventilation system comprises a first fan and a second fan,
the first fan is located in the first space to drive air circulation in the cooking container,
the second fan is located in the second space to drive air circulation in the second space and the heat dissipation space,
the ventilation system further comprises an air outlet element,
the air outlet element comprises a first air outlet and a second air outlet,
the first air outlet is connected to the first space,
the second air outlet is connected to the second space, and
a protruding enclosing wall of the air outlet element on a side of the air outlet element facing the second space and the heat dissipation space is elliptical.

2. The air fryer according to claim 1, wherein:
the second space is located above the first space, and
the air outlet element is placed laterally at a junction between the first space and the second space.

3. The air fryer according to claim 2, wherein:
the first air outlet and the second air outlet extend laterally.

4. The air fryer according to claim 2, wherein:
the first space and the second space are separated by a heat insulating cover.

5. The air fryer according to claim 2, wherein:
an upper half part of the protruding enclosing wall is located in the second space,
a lower half part of the protruding enclosing wall is located in the heat dissipation space, and
the second fan is configured to drive air to flow along an outer side of the lower half part of the protruding enclosing wall and along an outer side of the upper half part of the protruding enclosing wall.

6. The air fryer according to claim 4, wherein:
an air inlet of the first space is located on the heat insulating cover.

7. The air fryer according to claim 1, wherein:
a bottom of the heat dissipation space comprises a bottom air outlet.

8. The air fryer according to claim 4, wherein:
the air fryer body further comprises an upper shell, and
the second space is formed between the upper shell and the heat insulating cover.

9. The air fryer according to claim 8, wherein:
the air outlet element is connected to the upper shell.

10. The air fryer according to claim 9, wherein:
a heat resistance of the upper shell is higher than a heat resistance of the air outlet element.
